(19) United States
(12) Patent Application Publication
(10) Pub. No.: US 2026/0047969 A1
(43) Pub. Date: Feb. 19, 2026

(54) Beauty Bed

(71) Applicant: Elizabeth McIntosh, West Bloomfield, MI (US)

(72) Inventor: Elizabeth McIntosh, West Bloomfield, MI (US)

(21) Appl. No.: 18/801,893

(22) Filed: Aug. 13, 2024

(51) Int. Cl. A61G 7/057; A61G 7/002; A61G 7/07; A61G 7/075

(52) U.S. Cl. CPC A61G 7/05723; A61G 7/002; A61G 7/072; A61G 7/0755

(57) ABSTRACT

The Beauty Bed 1 consists of two separate pieces 2,3 of supportive foam with a luxurious top layer of memory foam, wrapped in machine washable, beautiful breathable fabric, with a contoured pillow 9 on the head section 3, and Velcro 8 underneath the head section 3 to secure the head section 3 to the wooden frame 4's Velcro 7 underneath and also to allow any sized person to extend the head section 3 and foot section 2 as necessary to fit their body. The foot section 2 also has Velcro underneath to secure the foot section 2 to the wooden frame 4's Velcro 7 underneath. On the ends of the head section 3, are two pockets 5 to store, tissues or glasses or phones, water or whatever.

### BACKGROUND OF THE INVENTION

According to the Academy of Plastic Surgeons, “during the first six weeks of recovery, the newly injected fat cells are susceptible to pressure necrosis, therefore it is important to refrain from sitting or lying on the buttocks for prolonged periods of time”. Preventing pressure necrosis also allows for the newly injected fat cells to become viable and gain good blood flow and circulation. It's crucial for the patient to follow the surgeon's post-operative instructions carefully to ensure the best possible outcome from the procedure. It's understandable that following the recommendations to stay off the buttocks can be challenging, during recovery and especially while trying to sleep. For clients who have had a tummy tuck procedure, excessive tension on the incision prevents them from lying flat or comfortably on a bed. When there are both procedures combined, the client can experience extreme discomfort and disruption in their rest. As a Certified Lymphatic Drainage Therapist, I sought a solution to keeping the client off of their buttock while performing a complete manual lymphatic drainage treatment; this is the birth of the Beauty Bed for Post Operative Recovery.

### SUMMARY OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The Beauty Bed 1 consists of two separate pieces 2,3 of supportive foam with a luxurious top layer of memory foam, wrapped in machine washable, beautiful breathable fabric, with a contoured pillow 9 on the head section 3, and Velcro 8 underneath the head section 3 to secure the head section 3 to the wooden frame 4's Velcro 7 underneath and also to allow most any sized person to extend the head section 3 and foot section 2 as necessary to fit their body. The foot section 2 also has Velcro underneath to secure the foot section 2 to the wooden frame 4's Velcro 7 underneath. At the ends of the head section 3, are two pockets to stow, tissues or glasses or phones, water or whatever. The Beauty Bed can be located on the floor or atop a bed. The Beauty Bed offers the flexibility to suit your preferences and space, however the bed was constructed to mimic a bed; therefore, the floor may be the safest option.

The Velcro straps 7 on the head 3 and foot 2 and the wooden platform 4 adhere the head section 3 and foot section 2 to the wooden frame 7, such that the head section 3 and foot section 2 remain supported by the wooden frame 7 throughout the night.

The Beauty Bed, for post operative recovery, is an ultimate solution for post-Brazilian Butt Lift (BBL) and Tummy Tuck and many other post surgical procedures recovery and comfort. Designed with the utmost care and innovation, The Beauty Bed is here to revolutionize your rest during the recovery experience.

### BRIEF DESCRIPTION OF DRAWINGS

FIG. 1 illustrates the entire The Beauty Bed 1, the foot portion 2, and the head portion 3, deconstructed in that the wooden platform 4 that gives the bed support from head to toe lies alongside The Beauty Bed 1 instead of underneath The Beauty Bed 1.

FIG. 2 illustrates the entire The Beauty Bed 1, with wooden platform 4 lying underneath The Beauty Bed 1, the foot portion 2, and the head portion 3. Also shown is pocket 5 at the end of the head of The Beauty Bed 3, and not shown but there is another pocket 5 on the other end of head portion 3 of The Beauty Bed 1.

FIG. 3 illustrates an end view of simply the head portion 3 of The Beauty Bed 1, highlighting pocket 5, which is located on the end of the head portion 3 of The Beauty Bed 1 and not shown but there is another pocket 5 on the other end of head portion 3 of The Beauty Bed.

FIG. 4 illustrates the wooden frame 4 bent and is located underneath The Beauty Bed.

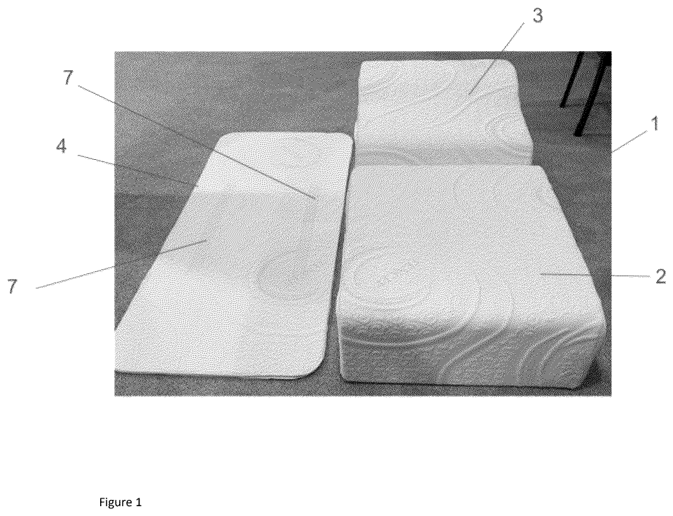

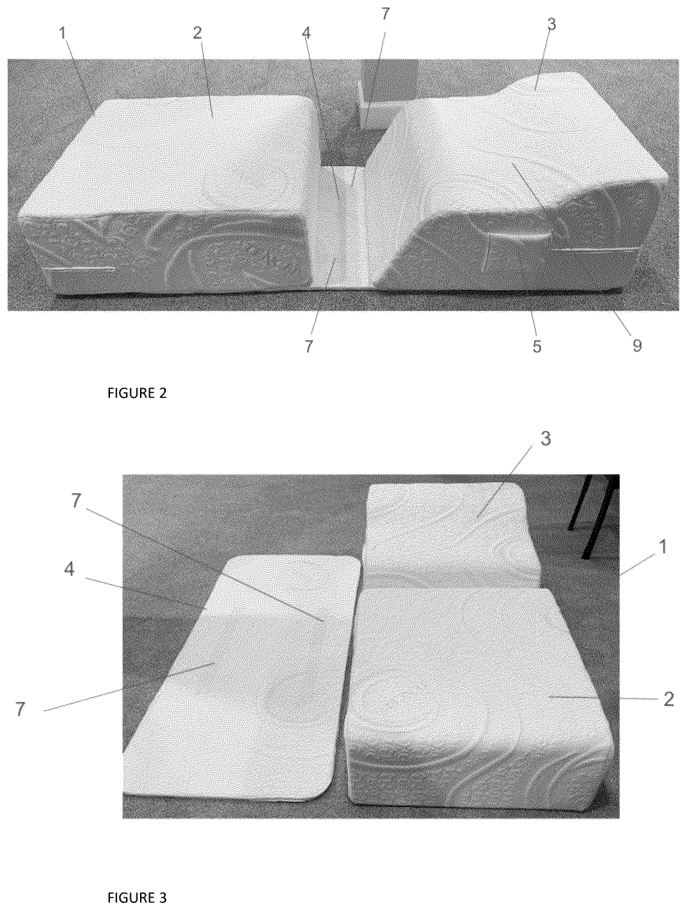

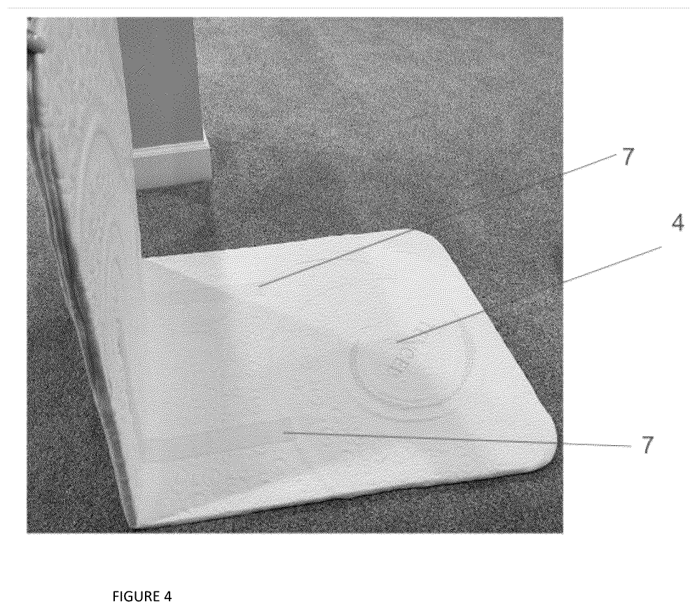

### DETAILED DESCRIPTION OF THE INVENTION

The Beauty Bed, for post-operative recovery, is an ultimate solution for post-elective surgery, Brazilian Butt Lift (BBL) and Tummy Tuck recovery and comfort. Designed with the utmost care and innovation, The Beauty Bed is here to revolutionize your recovery experience. Let's take a closer look at what makes this remarkable product a must-have for anyone undergoing BBL surgery and or tummy tuck (abdominoplasty) or other procedures.

Innovative Design: The BBL Beauty Bed consists of two separate pieces of supportive foam with a luxurious top layer of memory foam, wrapped in machine washable, beautiful breathable fabric. It is designed to mimic a bed, providing both maximum comfort and support during your recovery.

Contoured Neck Support: The top section of the pillow bed features a contoured neck, provides support, relief and relaxation for your neck. This allows you to rest in a comfortable position without straining the neck.

The remainder section of the upper portion of the bed provides contoured support of the lower back that aids in compression and the reduction of fluid accumulation while providing superior comfort whether you choose to lay on your back or sides.

Convenient Side Pockets: You'll find two side pockets on the top section, perfect for keeping essential items like your cell phone, the TV remote or a bottle of water within easy reach. No need to get up and disrupt your rest.

Adjustable Velcro Strips: The bottom, of both sections, comes equipped with Velcro strips, allowing you to customize the distance between the two pieces according to your height. This feature ensures a perfect fit for every client and the Velcro prevents shifting from the platform.

Cushioned Leg Support: The second portion of the pillow bed mirrors the same construction as the top section and provides cushioned support and comfort for your legs. It mimics the feeling of lying in a bed, making your recovery process as comfortable as possible.

Secure Velcro Straps: To prevent shifting and sliding during the night, the second portion of the bed also features Velcro straps. This ensures that you stay in the ideal position recommended by your surgeon to keep your bum suspended and to prevent overextending the abdominal incision or the repair of the abdominal muscle.

Stable Wooden Platform: The Beauty Bed includes a wooden platform also encased in machine washable fabric with Velcro straps to keep the pillows securely in place. This feature ensures that the pillows won't shift and cause discomfort or hinder your recovery progress.

Versatile Use: Whether you prefer to use it on the floor or on top of your bed, The Beauty Bed offers the flexibility to suit your preferences and space. (Due to the increase in height when The Beauty Bed is placed atop a bed, it is recommended to be used on the floor, to prevent a user from falling off of The Beauty Bed on the bed onto the floor and risk injury from the fall.

Comfort in All Positions: This innovative product allows you to sleep comfortably on your back and/or side while adhering to your surgeon's instructions for post-BBL care. It supports your entire body, making it easier to get the rest you need during the crucial healing and recovery period.

In conclusion, The BBL Beauty Bed is a game-changer in the marketplace in post-BBL recovery beds. With its thoughtful design, adjustable features, and exceptional comfort, it's the ideal choice for anyone looking to make their recovery journey as smooth and comfortable as possible. Invest in your well-being with The BBL Beauty Bed and experience the difference it can make in your recovery process.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

I claim:

1. A bed comprising two separate pieces, the head and the foot, with space in between the two.

2. The bed of claim 1, wherein said head and said foot are comprised of supportive foam with a memory foam top.

3. The bed of claim 2, wherein said supportive foam with memory foam top are encased in machine washable, breathable fabric.

4. The bed of claim 1, and further comprising a contoured pillow on said head of said bed.

5. The bed of claim 1, and further comprising specifically placed Velcro straps underneath said head and said foot.

6. The bed of claim 1, wherein said space between the head and the foot fits most derrieres.

7. The bed of claim 1, and further comprising a wooden frame lying underneath said head and said foot.

8. The bed of claim 7, wherein said wooden frame comprises specifically placed Velcro strips on top of said wooden frame that are located where said specifically placed Velcro of said head and said foot are located.

9. The bed of claim 8, wherein said specifically placed Velcro strips underneath said head and said foot allow the user to customize the distance between said head and said foot according to the user's height.

10. The claim of claim 8, wherein said specifically placed Velcro strips underneath said head and said foot adhere to the specifically placed Velcro strips on said wooden frame.
